(19) United States
(12) Patent Application Publication
(10) Pub. No.: US 2026/0221628 A1
(43) Pub. Date: Jul. 30, 2026

(54) BATTERY CELL TEMPERATURE MEASUREMENT SYSTEM

(71) Applicant: CPS Technology Holdings LLC, New York, NY (US)

(72) Inventors: Mark D. GUNDERSON, Bristol, WI (US); Ronald J. DULLE, Mequon, WI (US); Rengaraj BALAKRISHNAN, Raleigh, NC (US)

(21) Appl. No.: 19/143,656

(22) PCT Filed: Dec. 29, 2023
(86) PCT No.: PCT/US2023/086450

§ 371 Date: Jun. 26, 2025

Related U.S. Application Data
(60) Provisional application No. 63/477,658, filed on Dec. 29, 2022.

(51) Int. Cl. H01M 50/569; H01M 10/42; H01M 10/48; H01M 50/204; H01M 50/284; H01M 50/503; H01M 50/552; H01M 50/553

(52) U.S. Cl. CPC H01M 50/569; H01M 10/4257; H01M 10/482; H01M 10/486; H01M 50/204; H01M 50/284; H01M 50/503; H01M 50/553; H01M 50/561; H01M 2010/4271

(57) ABSTRACT

A system for determining a temperature value of a battery cell is described. The system includes a post directly couplable to the battery cell. The post has a post temperature corresponding to a temperature associated with the battery cell. The system also includes a thermally conductive pad coupled to the post and a sensor. The sensor is physically coupled to the thermally conductive pad and configured to measure the temperature associated with the battery cell via the thermally conductive pad and the post. The system also includes a battery management system (BMS) that includes processing circuitry in communication with the sensor and configured to determine the temperature value of the battery cell based on the measured temperature associated with the battery cell.

### TECHNICAL FIELD

This disclosure relates to batteries and in particular to a smart battery to facilitate battery performance/failure monitoring.

### BACKGROUND

As battery technology evolves, the demand for improved power sources such as energy storage modules for vehicles continues to grow. Existing battery systems, for example lead acid battery systems, typically offer limited access to performance and failure monitoring. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the battery cells. Accordingly, the state of health of battery cells cannot be monitored and/or determined, thus hindering the ability to predict upcoming battery failure or the onset of failure.

### SUMMARY

Some embodiments advantageously provide a method and apparatus, e.g., smart battery. In some embodiments the apparatus includes element(s) connecting at least one lead to a corresponding battery cell. The lead(s) may be connected to a battery management system (BMS), e.g., to determine/measure at least one parameter, such as cell temperature, voltage, current, etc. In some embodiments, one lead is connected to a terminal of the battery and another lead is connected to one battery cell. In some other embodiments, more than one lead is connected to battery cells. In a nonlimiting example, the battery includes six leads, where each one of five leads is connected to one battery cell, and the sixth lead is connected to a positive terminal of the battery. However, the battery is not limited as such and may include any quantity of leads and/or each lead be connected to one or more components of the battery, e.g., battery cells. In some other embodiments, connecting leads to battery cells includes connecting each lead to one post that is connected to one battery cell.

In one or more embodiments, battery cell temperature sensing is described, e.g., for multiple battery sizes. In some other embodiments, a printed circuit board (PCB) mount temperature sensor (i.e., circuit element) is described, e.g., flexible circuit or wired interface may not be required. In some embodiments, a thermal pad providing thermal conductor and electrical insulator to cast-on strap (COS) for battery cell temperature is described. Multiple thermal sensors and locations may be used for different group sizes (e.g., battery group sizes, thermal pads, battery component sizes, etc.). In some embodiments, the thermal pad may have a predetermined dimension (e.g., length, width, height).

Further, in some other embodiments, a cell voltage sense concept is described. More specifically, a lead guide is described. The lead guide may comprise openings having tapered barrels. The opening may comprise through hole tapered barrels which may be inserted in the board (e.g., PCB) of the BMS to provide a guide and connection point to a lead assembly (e.g., lead frame) to facilitate assembly of the battery.

In some embodiments, a snap-fit lead guide may be used such as to support a BMS connector (e.g., pin) insertion. In some other embodiments, a connector for parameter sensing such as voltage sensing (Vsense) is described.

According to one aspect, a system for determining a temperature value of a battery cell is described. The system includes a post directly couplable to the battery cell. The post has a post temperature corresponding to a temperature associated with the battery cell. The system also includes a thermally conductive pad coupled to the post and a sensor. The sensor is physically coupled to the thermally conductive pad and configured to measure the temperature associated with the battery cell via the thermally conductive pad and the post. The system also includes a battery management system (BMS) that includes processing circuitry in communication with the sensor and configured to determine the temperature value of the battery cell based on the measured temperature associated with the battery cell.

In some embodiments, the thermally conductive pad is arranged to transfer thermal energy to the sensor.

In some other embodiments, the sensor is configured to measure the temperature associated with the battery cell based on the transferred thermal energy.

In some embodiments, the sensor is a thermistor.

In some other embodiments, the BMS includes a circuit board. The sensor is coupled to the circuit board, protruding from the circuit board, and enclosed by the thermally conductive pad.

In some embodiments, the system further includes a bushing couplable to the battery cell and coupled to the post. The post and the bushing are arranged to thermally conduct thermal energy from the battery cell to the thermally conductive pad.

In some other embodiments, the post and bushing are integrated in single unitary construction.

In some embodiments, the thermally conductive pad has a size based on a battery cell characteristic, and the sensor is configured based on the size of the thermally conductive pad.

According to another aspect, a battery is described. The battery includes a plurality of battery cells, a plurality of posts, a case, a cover, one or more thermally conductive pads, a sensor, and a battery management system (BMS). Each post of the plurality of posts is coupled to one or more battery cells of the plurality of battery cells. Each post has a post temperature corresponding to a temperature associated with the one or more battery cells. The case houses the plurality of battery cells and at least a portion of each posts of the plurality of posts. The cover is sealed to the case and includes a plurality of bushings. At least another portion of each post of the plurality of posts extends from the cover via a corresponding bushing. Each thermally conductive pad is coupled to one post and one bushing. The sensor is physically coupled to each thermally conductive pad of the one or more thermally conductive pads. The sensor is configured to measure a temperature associated with at least one battery cell via the thermally conductive pad and a corresponding post. The BMS includes processing circuitry in communication with the sensor and configured to determine a temperature value of each battery cell based on the measured temperature associated with the at least one battery cell.

In some embodiments, the battery further includes a plurality of leads, where each lead has a first end and a second end. The first end is electrically coupled to one post and one bushing, and the second end is electrically coupled to the BMS.

In some other embodiments, the processing circuitry is further configured to determine, via each lead, a battery cell parameter other than a temperature value or measured temperature associated with the at least one battery cell.

In some embodiments, the thermally conductive pad is arranged to transfer thermal energy to the sensor, and the sensor is configured to measure the temperature associated with the at least one battery cell based on the transferred thermal energy.

According to one aspect, a method for assembling a system for determining a temperature value of a battery cell is described. The system includes a weld, a thermally conductive pad, a sensor configured to measure a temperature associated with the battery cell via the thermally conductive pad, a battery management system (BMS) and a lead. The weld is directly couplable to the battery cell and has a weld temperature corresponding to a temperature associated with the battery cell. The lead has a first end and a second end opposite the first end. The method includes coupling the first end of the lead to the weld and the second end of the lead to the BMS, coupling the sensor to the thermally conductive pad, and positioning a bottom surface of the thermally conductive pad over the weld and the lead. The method further includes coupling the thermally conductive pad to the weld, where at least a portion of the bottom surface of the thermally conductive pad directly contacts only the weld, and electrically coupling the BMS to the sensor.

In some embodiments, the method further includes creating a cavity in the thermally conductive pad.

In some other embodiments, the method further includes inserting the sensor in the cavity.

In some embodiments, the weld includes a post and a bushing coupled to the post, where the post is directly couplable to the battery cell, and the thermally conductive pad is arranged to transfer thermal energy to the sensor.

In some other embodiments, the method further includes welding the post and the bushing to form the weld.

In some embodiments, the system further includes the battery cell, and the method further includes coupling the post to the battery cell.

In some other embodiments, the BMS further includes a circuit board comprising processing circuitry, and the method further includes coupling the sensor to the circuit board, the sensor protruding from the circuit board.

In some embodiments, the method further includes electrically coupling the sensor to the processing circuitry.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows example leads according to the principles of the present disclosure;

FIG. 4 shows an example lead assembly according to the principles of the present disclosure;

FIG. 5 shows an example lead assembly connected to corresponding couplings according to the principles of the present disclosure;

FIG. 6 shows an example battery management system (BMS) coupled to a lead assembly according to the principles of the present disclosure;

FIG. 7 shows steps of coupling a pad to one or more components of a battery according to the principles of the present disclosure;

FIG. 8 shows a view of an example pad coupled to one or more components of a battery according to the principles of the present disclosure;

FIG. 9 shows a view of an example board of a BMS according to the principles of the present disclosure;

FIG. 10 shows another view of the example board of the BMS according to the principles of the present disclosure;

FIG. 11 shows an example BMS according to the principles of the present disclosure;

FIG. 12 shows an example process of assembly of a pad according to the principles of the present disclosure; and

FIG. 13 shows another example process of assembly of a pad according to the principles of the present disclosure.

### DESCRIPTION

As battery technology evolves, there is a need to provide improved power sources, and more efficient and effective methods for manufacturing such power sources as compared to conventional systems and methods.

Accordingly, embodiments described and shown herein provide a battery and method of assembly of the battery that allows smart features to be integrated within a battery that, in some embodiments, can take the same general shape and form as batteries that do not offer “smart” battery features, such as (as a non-limiting example) the ability to monitor individual cell voltages. In some embodiments, at least one lead to a corresponding battery cell may be connected to a battery management system (BMS), e.g., to determine/measure at least one parameter, such as cell voltage, cell current, cell temperature, etc. In some other embodiments, a pad (e.g., comprising a circuit element) may be used. In some other embodiments, lead guides are used for connecting leads to a BMS.

In some embodiments, the term “smart battery” may be used and may refer to a battery having, for example, lead, lithium or sodium chemistries, that are enabled by electronics physically attached to the battery for monitoring battery functional parameters, such as but not limited to state of charge, state of health and/or trends thereof, or communicating battery conditions internally within or externally from the battery environment. The electronics may be generally referred to as connected electronics and may include a battery management system or any other electronic component. Further, electronics may utilize wired or wireless transmission devices or communication interfaces configured for communication of data and/or information, such as applicable battery information and/or derivatives of the battery information.

In some embodiments, the term couple (or connect) may refer to physically and/or electrically coupling (e.g., connecting) one or more components. For example, coupling a first component to a second component comprises physically coupling and/or electrically coupling the first component to the second component. In some embodiments, coupling may comprise thermally coupling, i.e., establishing contact (direct/indirect) between a first and a second component. For example, a first component may be coupled to the second component where thermal energy is transferred or conducted from the first element to the second element and/or vice versa. In some other embodiments, coupling may further comprise coupling (e.g., physically coupling and/or electrically coupling) one or both of the first and second components to a third component.

In some embodiments, the term thermistor is used and may refer to an electrical circuit element which may be a type of resistor having a resistance that is dependent on temperature. For example, when using a thermistor, a variation in temperature corresponding to the thermistor causes a variation in resistance of the thermistor, e.g., resistance is directly proportional to the temperature.

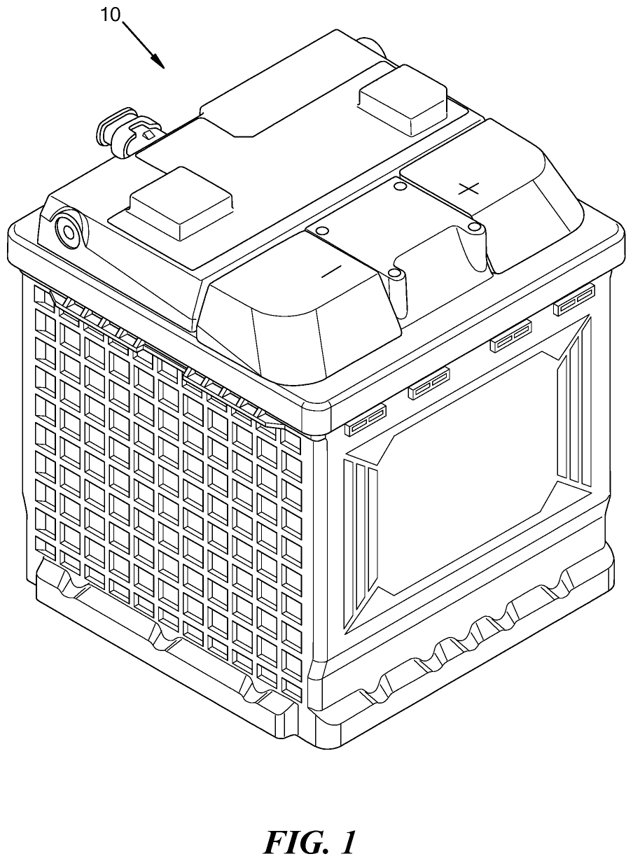

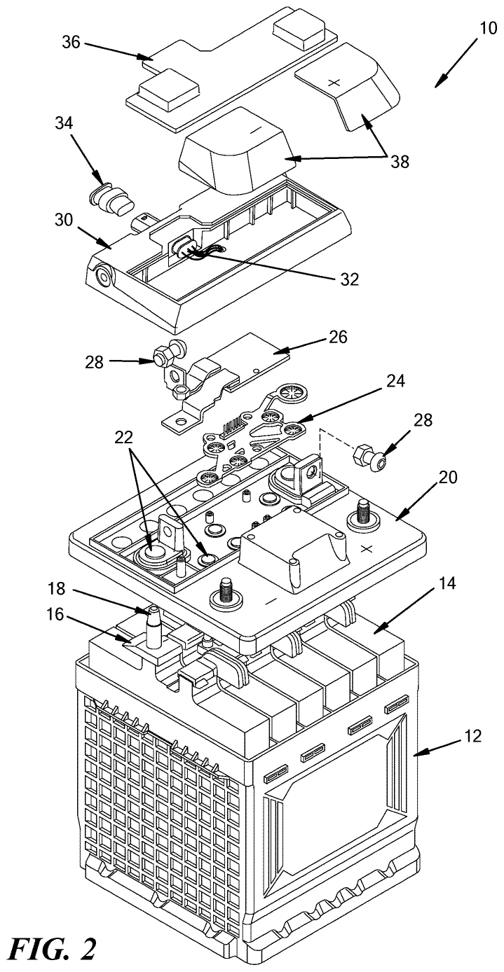

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 16 (e.g., Cast-On-Strap (COS) post assembly), one or more posts 18 (e.g., a terminal post, a mini-post), a first cover 20, one or more bushings 22 (e.g., a U1 bushing, a mini-bushing), a lead assembly 24 (e.g., a lead frame), a battery management system 26 (e.g., including a board), one or more fasteners 28, a second cover 30, a wiring harness 32, a vehicle connector 34, a third cover 36, and one or more terminal caps 38.

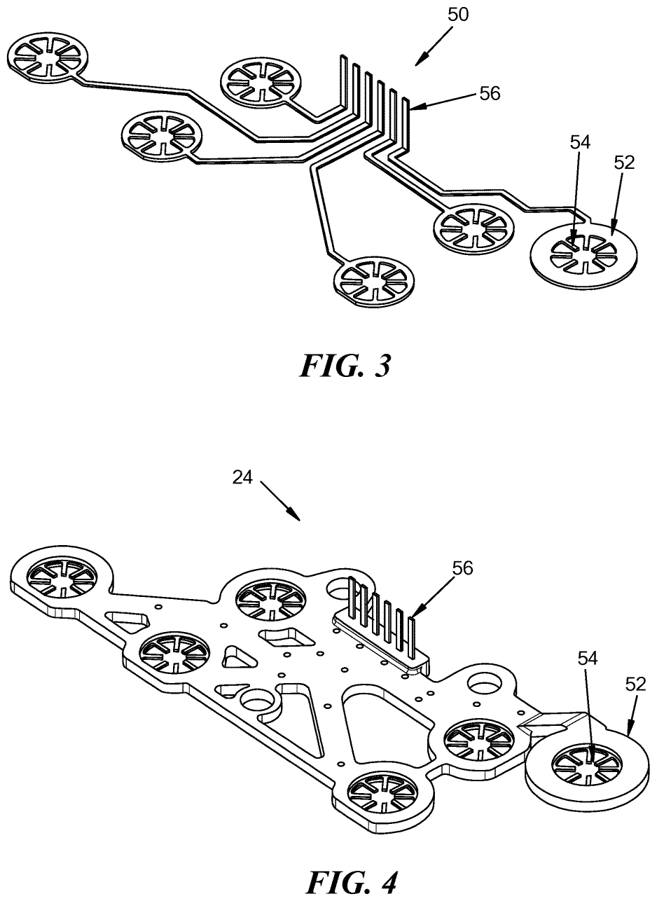

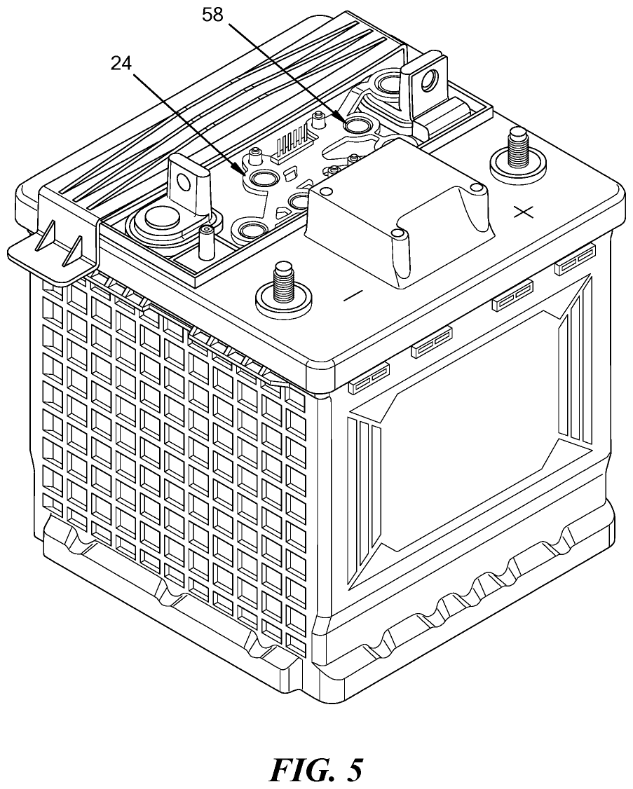

FIG. 3 shows an example of a plurality of leads 50 (e.g., six leads). FIG. 4 shows a lead assembly 24 (e.g., including the plurality of leads 50). Each lead 50 may include one or more of each of the following: a lead ring 52, a post connector 54 (e.g., a spoke) comprised in one end each lead 50, and a lead BMS connector 56 (e.g., pin, board connector, spade, etc.) comprised in another end of each lead 50. Ring 52 and/or post connector 54 may be arranged to physically and/or electrically connect lead 50 to a post 18 and bushing 22 (e.g., by being coupled (e.g., by welding it) to post 18 and/or bushing 22, and forming weld 58 (shown in FIG. 5)). BMS connector 56 may be arranged to extend from the ring and/or bend to a predetermined angle and/or physically and/or electrically connect to BMS 26 (and/or any of its components). Lead 50 may be made of any material including conductive materials, e.g., to conduct electricity and/or propagate signals. In a nonlimiting example, lead 50 may refer to a stamped frame and/or be made of at least one of copper, brass, steel, aluminum, titanium, platinum, etc. Further, lead 50 may include a coating and/or a finish such as a finish using copper, nickel, tin, palladium, silver, gold, zinc, etc. Lead 50 may be used by BMS 26 to measure/determine one or more parameters associated with battery cell 14. Parameters may include, without limitation, voltage, current, temperature, pressure, etc., and may be associated with any component of battery 10, e.g., post 18, battery cell 14, etc. Lead(s) 56 (e.g., stamped leads) may be comprised in a lead assembly 24 (e.g., an over molded assembly) as shown in FIG. 4. The lead assembly 24 may comprise lead frame. In some embodiments, the lead frame is a coating and/or finish.

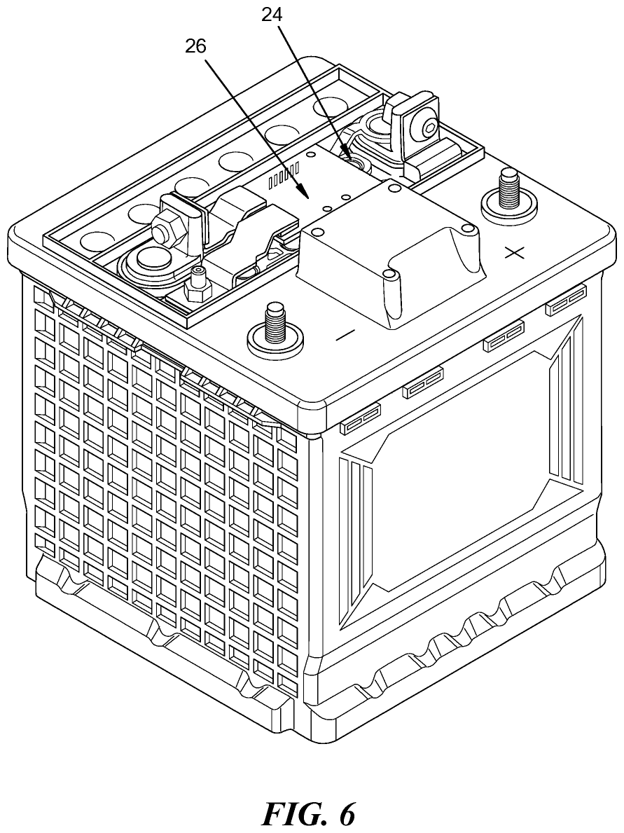

FIG. 5 shows an example lead assembly 24. Lead assembly 24 is coupled (e.g., physically and/or electrically coupled) to a weld 58 (e.g., a weld of bushing 22 and post 18). In other words, each one of leads 50 of lead assembly 24 is coupled to a corresponding post 18 and/or bushing 22 and/or battery cell 14 and may be used to measure a battery parameter such as voltage. Further, weld 58 may be coupled to a battery cell 14 and arranged to have a weld temperature that corresponds to the temperature of the battery cell 14. That is, weld temperature may be equal to or proportional to the temperature of the weld 58, such as when weld 58 is coupled to the battery cell 14, thereby facilitating the measurement of the temperature of the battery cell 14 via the weld 58. FIG. 6 shows an example BMS 26 coupled to a lead assembly 24. In this nonlimiting example, BMS 26 is electrically connected to one or more battery cells 14 via leads 50 of lead assembly 24.

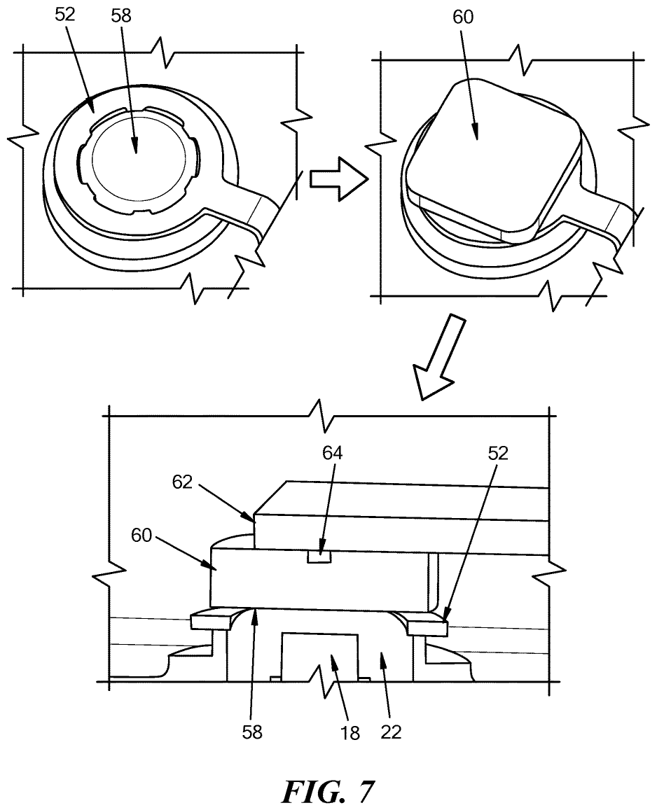

FIG. 7 shows example steps for coupling a pad 60 to one or more components of the battery 10 in accordance with the principles of the present disclose. A weld 58 (e.g., a weld electrically coupling a post 18 and bushing 22 to a lead 50) may be arranged to receive, make contact with, and/or couple to a pad 60. In some embodiments, pad 60 may be made of a thermally conductive material to provide a thermal conductive path from the weld 58 to a sensor 64. However, pad 60 is not limited as such and may be any kind of pad, which may facilitate measurement of any parameter such as a battery cell parameter. Sensor 64 may be any kind of sensor configured to measure a parameter such as a battery cell parameter. For example, sensor 64 may be a temperature sensor, a thermistor, etc. and may allow for measurement of battery cell temperature. Pad 60 may be electrically insulating with respect to the weld 58 and COS. That is, pad 60 may be arranged to conduct thermal energy and/or provide electrical insulation. When assembled, pad 60 may contact sensor 64 (e.g., thermistor) on circuit board 62 of BMS 26. In some embodiments, sensor 64 may be mounted to or incorporated within pad 60 (such as in a cavity of the pad that defines an internal space for receiving sensor 64). Sensor 64 may be electrically connected to a corresponding pad (e.g., configured in similar fashion as pad 60) on BMS circuit board 62. In some embodiments, pad 60 has a top surface and a bottom surface. In some other embodiments, the bottom surface of the pad 60 is placed over weld 58 and ring 52 of lead 50. Further, pad 60 may be coupled to weld 58, where at least a portion of the bottom surface of pad 60 only contacts weld 58, where the contact is a direct contact.

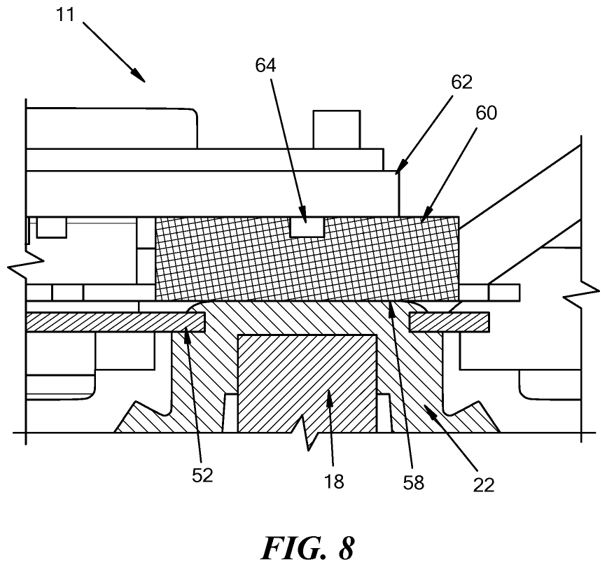

FIG. 8 shows a view of an example pad 60 of a temperature measurement system 11 incorporated in a battery 10, where the pad 60 is coupled to one or more components of the battery 10 according to the principles of the present disclosure and with BMS 26 installed. Pad 60 is shown in contact with sensor 64 (e.g., thermistor) and is coupled to bushing 22. The sensor 64 is located on circuit board 62 such that, when BMS 26 is installed during battery assembly, the sensor 64 aligns with and comes into contact with pad 60. Bushing 22 is coupled to lead ring 52 (e.g., copper ring) of lead 50 and coupled to post 18. Sensor 64 may be affixed and/or electrically coupled to board 62 (and/or any of its elements) of BMS 26. In some embodiments, sensor 64 may be arranged to respond to temperature changes such as by varying a parameter of the sensor 64, e.g., a variation of temperature triggers a variation of resistance. Further, sensor 64 may be electrically coupled to one or more circuit elements of board 62 of BMS 26. Pad 60 may be arranged to provide electrical insulation to one or more elements such as board 62 by allowing thermal energy to pass from post 18 to sensor 64, but not electricity. In some embodiments, system 11 refers to battery 10 and its components.

In one nonlimiting example, electrically conducive post 18 and/or bushing 22 may be made of thermally conductive materials and/or coupled to a corresponding battery cell 14. Although this disclosure refers to bushings 22 as the element upon which pad 60 is positioned, it is understood that particular implementations may not use a bushing 22. Other arrangements for providing thermal conduction from a battery cell 14 to pad 60 through the same electrically conductive element, e.g., post 18, etc., used measure battery cell 14 voltage, can be used.

In some embodiments, when the temperature of a battery cell 14 increases, thermal energy corresponding to the increase in temperature is conducted via post 18, bushing 22, pad 60, and/or sensor 64. Sensor 64 responds to the temperature increase (and/or the thermal energy conducted) by increasing its resistance. BMS 26 and/or board 62 and/or elements of BMS 26 may determine temperature of battery components such as battery cell 14, e.g., based on the resistance value (an/or variation of resistance) of the sensor 64. Thus, BMS 26 may be configured to determine one or more parameters of the battery cells 14 such as temperature (e.g., via pad 60) and voltage (via lead ring 52 of lead 50). In some embodiments, a single system 11 may be included in battery 10, i.e., a single point of temperature measurement which assumes a relatively equal temperature distribution among the battery cells 14. In other embodiments, circuit board 62 can include multiple sensors 64 to allow multiple points of contact with multiple pads 60 for multiple battery cells 14. In still other embodiments, sensors can be embedded in the pad 60 and separately electrically connected to BMS circuit board 62, thereby allowing individual battery cell 14 temperature measurements.

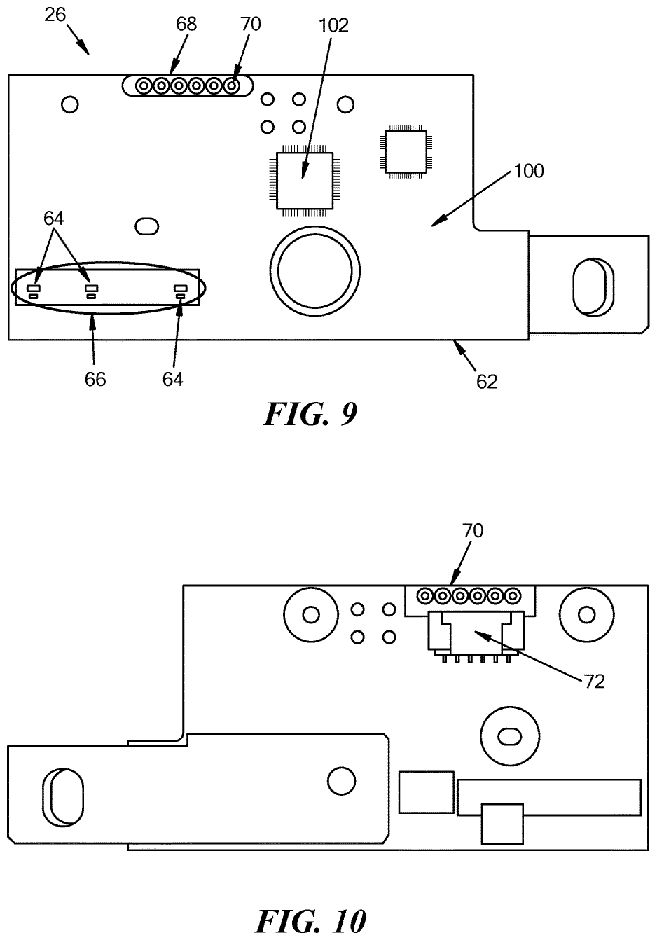

FIG. 9 shows a view of an example board 62 of a BMS 26 according to the principles of the present disclosure. BMS 26 may comprise a board 62, one or more sensors 64, processing circuitry 100, processor 102, etc. Sensors 64 may be positioned within a region 66 on the bottom of circuit board 62 that is separated from the other elements of BMS 26, e.g., to allow for thermal isolation such that the heating of the other elements of BMS 26 does not impact the reading of sensor 64 and the heating of sensor 64 does not impact the other elements. In some embodiments, further temperature isolation of region 66 is accomplished by affixing other elements of BMS 26 to the opposite, i.e., top, side of circuit board 62 while region 66 is located on the bottom side of circuit board 62. Providing multiple sensors 64 within region 66 of BMS circuit board 62 allows a single BMS 26 to be used in batteries of different physical sizes, e.g., different battery groups, while ensuring that the corresponding pad 60 will still come into physical contact with a sensor 64 when the BMS 26 is installed during battery assembly. Although FIG. 9 shows three sensors 64, it is understood that fewer than three or more than three sensors 64 can be used depending on the particular design requirements.

Further, BMS 26 may comprise a lead guide 68. Lead guide 68 may comprise one or more openings 70 (e.g., tampered barrels, tampered through hole barrels) which may receive leads 50 (and/or BMS connectors of the leads) and couple the leads to BMS 26. The tapered barrels serve to guide the pins of lead frame leads 50 through the corresponding openings in circuit board 62 during installation of the BMS 26 as part of the assembly of the battery, thereby providing an arrangement under which the lead frame leads 50 do not have to be perfectly aligned with their corresponding openings in the BMS circuit board 62 during battery assembly. This arrangement facilitates and speeds up assembly of the battery, and reduces the likelihood of a bend or unconnected lead 50.

FIG. 10 shows another view (e.g., opposite to the view of FIG. 9) of the example board 62 of the BMS 26 according to the principles of the present disclosure. BMS 26, comprising openings 70, may also include a connector 72 (e.g., Vsense connector or voltage sense connector), which may couple one or more leads 50 received by lead guide 68 to BMS 26 (and/or any of its components).

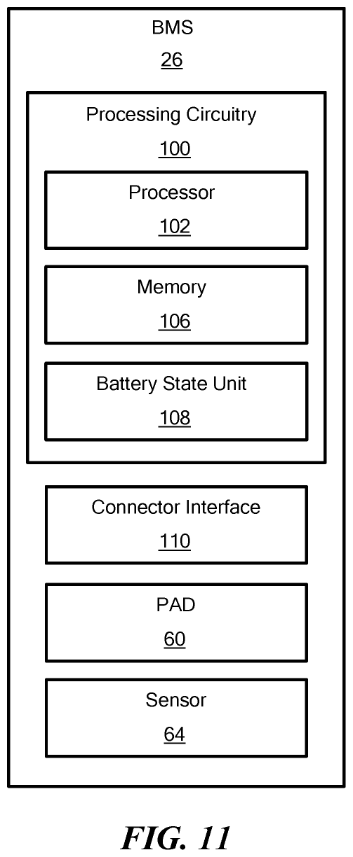

FIG. 11 shows an example BMS 26. BMS 26 may include at least one of processing circuitry 100, processor 102, memory 106, battery state unit 108, and connector interface 110. In some embodiments, BMS 26 also includes pad 60 and/or sensor 64 which may be configured to perform pad actions and sensor actions, respectively, and communicate with any of the other components of BMS 26. Processing circuitry 100, which may have storage and/or processing capabilities. The processing circuitry 100 may include processor 102 and memory 106. In particular, in addition to or instead of a processor, such as a central processing unit, and memory, the processing circuitry 100 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 102 may be configured to access (e.g., write to and/or read from) memory 106, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 100 may be configured to control any of the methods and/or processes described herein and/or to cause such methods, and/or processes to be performed, e.g., by BMS 26 and/or battery 10. Processor 102 corresponds to one or more processors 102 for performing battery 10 functions described herein. Memory 106 may be configured to store data, programmatic software code and/or other information described herein. In some embodiments, software may include instructions that, when executed by the processor 102 and/or processing circuitry 100, causes the processor 102 and/or processing circuitry 100 to perform the processes described herein. The instructions may be software associated with BMS 26 and/or battery 10. Further, battery state unit 108 may be configured to perform any of the steps and/or methods and/or functions and/or processes and/or features of the present disclosure, e.g., by BMS 26 and/or battery 10. Connector interface 110 may be any interface arranged/configured to connect to (and/or communicate with) any other device and/or component of battery 10 such as any lead 50 and/or vehicle connector 34 and/or wiring harness 32 and/or any device by wireless/wired communication, e.g., using any communication protocol. Connector interface 110 may be in communication with any of the components of battery 10, such as pad 60, sensor 64, processing circuitry 100, processor 102, memory 106, and/or battery state unit 108.

In a nonlimiting example, BMS 26 is configured to determine (i.e., capture, measure, read, etc.) data including battery cell data and/or battery cell parameters, e.g., via processing circuitry 100 and/or connector interface 110 and/or lead 50 of lead assembly 24 and/or post 18 and/or bushing 22 and/or pad 60 and/or sensor 64 and/or lead guide 68 and/or openings 70 and/or battery cells 14. More specifically, BMS 26 may be configured to determine a temperature of a battery cell 14 and/or battery 10 by using a connection that is established between BMS 26 and the battery cell 14 via pad 60, sensor 64, bushing 22, post 18 and battery cells 14. BMS 26 may be configured to determine a voltage of a battery cell 14 and/or battery 10 by using an electrical connection that is established between BMS 26 and the battery cell 14 via leads 50, lead guide 68, bushing 22, post 18 and battery cells 14. Further, BMS 26 may be further configured to analyze the data. BMS 26 may also be configured to communicate the analyzed data or any other data, e.g., transmit/receive data which may include battery cell data and/or battery cell parameters, e.g., via wiring harness 32 and/or vehicle connector 34 and/or connector interface 110. The analyzed data or any other data may be transmitted to and/or received from another device, e.g., that may be connected to BMS 26 such as via vehicle connector 34 and/or connector interface 110. Communicating data may be performed using a protocol such as CAN and/or LIN via vehicle connector 34 to a vehicle and/or Bluetooth via connector interface 110 to a customer. That is, communicating data is not limited to wired connections/protocols and may also include the use of any wireless connections/protocols to communicate to one or more devices/systems. The arrangement described above is beneficial at least because battery 10 is capable of capture data such as battery cell data (e.g., lead acid battery cell data) and/or process the data and/or communicate the data for monitoring and/failure prediction of battery cells and other battery components.

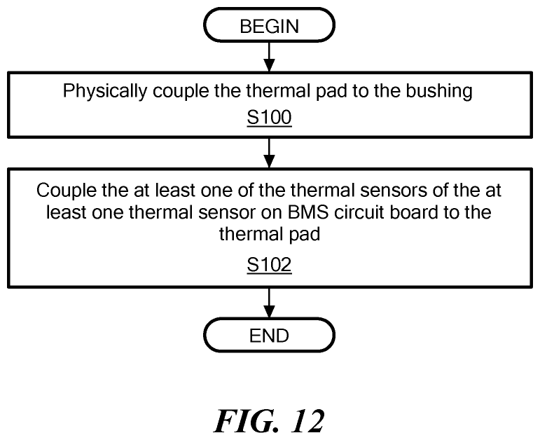

FIG. 12 shows an example method for assembling a system 11 for measuring temperature of a battery cell 14. The system 11 comprises a pad 60, a battery management system (BMS) 26 having a circuit board 62 and at least one sensor 64 affixed to the circuit board, and a thermally conductive bushing 22 indirectly couplable to the battery cell 14. The method comprises physically coupling the pad 60 to the bushing 22 (step S100). The method further comprises coupling at least one of the sensors 64 of the at least one sensor 64 on BMS circuit board 62 to the pad 60 (step S102).

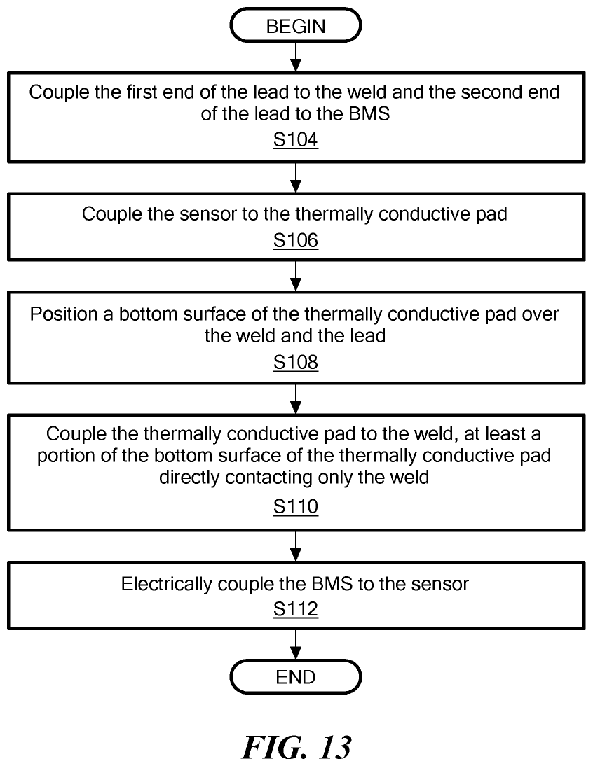

FIG. 13 shows another example method of assembly of the system 11 for determining a temperature value of a battery cell 14 is described. The system 11 includes a weld 58, a thermally conductive pad 60, a sensor 64 configured to measure a temperature associated with the battery cell 14 via the thermally conductive pad 60, a battery management system (BMS) 26 and a lead 50. The weld 58 is directly couplable to the battery cell 14 and has a weld temperature corresponding to a temperature associated with the battery cell 14. The lead has a first end and a second end opposite the first end. The method includes coupling the first end of the lead to the weld and the second end of the lead to the BMS 26, coupling the sensor 64 to the thermally conductive pad 60, and positioning a bottom surface of the thermally conductive pad 60 over the weld 58 and the lead 50. The method further includes coupling the thermally conductive pad 60 to the weld 58, where at least a portion of the bottom surface of the thermally conductive pad 60 directly contacts only the weld 58, and electrically coupling the BMS 26 to the sensor 64.

In some embodiments, the method further includes creating a cavity in the thermally conductive pad 60.

In some other embodiments, the method further includes inserting the sensor 64 in the cavity.

In some embodiments, the weld 58 includes a post 18 and a bushing 22 coupled to the post 18, where the post 18 is directly couplable to the battery cell 14, and the thermally conductive pad 60 is arranged to transfer thermal energy to the sensor 64.

In some other embodiments, the method further includes welding the post 18 and the bushing 22 to form the weld 58.

In some embodiments, the system 11 further includes the battery cell 14, and the method further includes coupling the post 18 to the battery cell 14.

In some other embodiments, the BMS 26 further includes a circuit board 62 comprising processing circuitry 100, and the method further includes coupling the sensor 64 to the circuit board 62, the sensor 64 protruding from the circuit board 62.

In some embodiments, the method further includes electrically coupling the sensor 64 to the processing circuitry 100.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and following claims.

1. A system for determining a temperature value of a battery cell, the system comprising:
a post directly couplable to the battery cell and having a post temperature corresponding to a temperature associated with the battery cell;
a thermally conductive pad coupled to the post;
a sensor being physically coupled to the thermally conductive pad and configured to measure the temperature associated with the battery cell via the thermally conductive pad and the post; and
a battery management system, BMS, comprising processing circuitry in communication with the sensor and configured to determine the temperature value of the battery cell based on the measured temperature associated with the battery cell.

2. The system of claim 1, wherein the thermally conductive pad is arranged to transfer thermal energy to the sensor.

3. The system of claim 2, wherein the sensor is configured to measure the temperature associated with the battery cell based on the transferred thermal energy.

4. The system of claim 1, wherein the sensor is a thermistor.

5. The system of claim 1, wherein the BMS comprises a circuit board, the sensor being coupled to the circuit board, protruding from the circuit board, and being enclosed by the thermally conductive pad.

6. The system of claim 1, wherein the system further includes:
a bushing couplable to the battery cell and coupled to the post, the post and the bushing being arranged to thermally conduct thermal energy from the battery cell to the thermally conductive pad.

7. The system of claim 6, wherein the post and bushing are integrated in single unitary construction.

8. The system of any claim 1, wherein the thermally conductive pad has a size based on a battery cell characteristic, and the sensor is configured based on the size of the thermally conductive pad.

9. A battery comprising:
a plurality of battery cells;
a plurality of posts, each post of the plurality of posts being coupled to one or more battery cells of the plurality of battery cells, each post having a post temperature corresponding to a temperature associated with the one or more battery cells;
a case housing the plurality of battery cells and at least a portion of each post of the plurality of posts;
a cover sealed to the case and comprising a plurality of bushings, at least another portion of each post of the plurality of posts extending from the cover via a corresponding bushing;
one or more thermally conductive pads, each thermally conductive pad being coupled to one post and one bushing;
a sensor physically coupled to each thermally conductive pad of the one or more thermally conductive pads, the sensor being configured to measure a temperature associated with at least one battery cell via the thermally conductive pad and a corresponding post; and
a battery management system, BMS, comprising processing circuitry in communication with the sensor and configured to determine a temperature value of each battery cell based on the measured temperature associated with the at least one battery cell.

10. The battery of claim 9, wherein the battery further includes:
a plurality of leads, each lead having a first end and a second end, the first end being electrically coupled to one post and one bushing, the second end being electrically coupled to the BMS

11. The battery of claim 10, wherein the processing circuitry is further configured to:
determine, via each lead, a battery cell parameter other than a temperature value or measured temperature associated with the at least one battery cell.

12. The battery of claim 9, wherein the thermally conductive pad is arranged to transfer thermal energy to the sensor, and the sensor is configured to measure the temperature associated with the at least one battery cell based on the transferred thermal energy.

13. A method for assembling a system for determining a temperature value of a battery cell, the system comprising a weld, a thermally conductive pad, a sensor configured to measure a temperature associated with the battery cell via the thermally conductive pad, a battery management system, BMS, and a lead, the weld being directly couplable to the battery cell and having a weld temperature corresponding to a temperature associated with the battery cell, the lead having a first end and a second end opposite the first end, the method comprising:
coupling the first end of the lead to the weld and the second end of the lead to the BMS;
coupling the sensor to the thermally conductive pad;
positioning a bottom surface of the thermally conductive pad over the weld and the lead;
coupling the thermally conductive pad to the weld, at least a portion of the bottom surface of the thermally conductive pad directly contacting only the weld; and
electrically coupling the BMS to the sensor.

14. The method of claim 13, wherein the method further includes:
creating a cavity in the thermally conductive pad.

15. The method of claim 14, wherein the method further includes:
inserting the sensor in the cavity.

16. The method of claim 13, wherein the weld comprises a post and a bushing coupled to the post, the post being directly couplable to the battery cell, and the thermally conductive pad is arranged to transfer thermal energy to the sensor.

17. The method of claim 16, wherein the method further includes:
welding the post and the bushing to form the weld.

18. The method of claim 13, wherein the system further includes the battery cell, and the method further includes:
coupling the post to the battery cell.

19. The method of claim 13, wherein the BMS further includes a circuit board comprising processing circuitry, and the method further includes:
coupling the sensor to the circuit board, the sensor protruding from the circuit board.

20. The method of claim 19, wherein the method further includes electrically coupling the sensor to the processing circuitry.
